(19) United States
(12) Patent Application Publication
(10) Pub. No.: US 2025/0338000 A1
(43) Pub. Date: Oct. 30, 2025

(54) IMAGE TRANSMISSION UNIT, OPTICAL DEVICE, AND MANUFACTURING METHOD FOR IMAGE TRANSMISSION UNIT

(71) Applicant: OLYMPUS CORPORATION, Tokyo (JP)

(72) Inventor: Takehiro MIKI, Tokyo (JP)

(73) Assignee: OLYMPUS CORPORATION, Tokyo (JP)

(21) Appl. No.: 19/227,867

(22) Filed: Jun. 4, 2025

Related U.S. Application Data
(63) Continuation of application No. PCT/JP2022/045250, filed on Dec. 8, 2022.

(51) Int. Cl. H04N 23/55; G02B 3/00; H04N 23/50; H04N 23/56

(52) U.S. Cl. CPC H04N 23/55; H04N 23/555; H04N 23/56; G02B 3/0087

(57) ABSTRACT

An image transmission unit includes: a single objective lens including a single truncated spherical lens having a flat surface and a convex spherical surface; an image transmission medium disposed at a side of the convex spherical surface of the objective lens; and a single holding member that holds both the objective lens and the image transmission medium. The objective lens and the image transmission medium satisfy expression of r/n<d≤r, where r denotes a radius of the objective lens, n denotes a refractive index of the objective lens, and d denotes a radius of the image transmission medium, and light passing through the flat surface includes light passing through an outermost periphery of the image transmission medium.

### CROSS-REFERENCE TO RELATED APPLICATIONS

This is a continuation of International Application PCT/JP2022/045250 which is hereby incorporated by reference herein in its entirety.

### TECHNICAL FIELD

The present invention relates to image transmission units, optical devices, and manufacturing methods for image transmission units.

### BACKGROUND ART

A known optical unit in the related art includes multiple truncated spherical lenses and a tubular holding member that holds the multiple truncated spherical lenses (for example, see Patent Literature 1). The truncated spherical lenses each have a three-dimensional shape obtained by cutting a sphere along one plane. The use of truncated spherical lenses facilitates size reduction of the optical unit, whereby an optical unit suitable for use as an objective optical system of a narrow endoscope can be readily manufactured.

### CITATION LIST

### Patent Literature

### {PTL 1}

PCT International Publication No. WO 2021/255929

### SUMMARY OF INVENTION

An aspect of the present invention provides an image transmission unit including: a single objective lens including a single truncated spherical lens having a flat surface and a convex spherical surface; an image transmission medium disposed at a side of the convex spherical surface of the objective lens; and a single holding member that holds both the objective lens and the image transmission medium. The objective lens and the image transmission medium satisfy expression (1) indicated below, and light passing through the flat surface includes light passing through an outermost periphery of the image transmission medium:

$$r / n < d \leq r \qquad ( 1 )$$

where r denotes a radius of the objective lens, n denotes a refractive index of the objective lens, and d denotes a radius of the image transmission medium.

Another aspect of the present invention provides an optical device including: an image transmission unit including a single objective lens including a single truncated spherical lens having a flat surface and a convex spherical surface, an image transmission medium disposed at a side of the convex spherical surface of the objective lens, and a single holding member that holds both the objective lens and the image transmission medium; and an optical element disposed at a side of the image transmission medium opposite from the objective lens. The objective lens and the image transmission medium satisfy expression (1) indicated below, and light passing through the flat surface includes light passing through an outermost periphery of the image transmission medium:

$$r / n < d \leq r \qquad ( 1 )$$

where r denotes a radius of the objective lens, n denotes a refractive index of the objective lens, and d denotes a radius of the image transmission medium.

Another aspect of the present invention provides a manufacturing method of an image transmission unit including: inserting a single spherical lens into a tubular holding member; inserting an image transmission medium into the holding member; forming a flat surface on the spherical lens by grinding an end of the holding member and the spherical lens; and positioning the spherical lens, having the flat surface formed thereon, and the image transmission medium relative to each other to a position where light passing through the flat surface includes light passing through an outermost periphery of the image transmission medium.

### BRIEF DESCRIPTION OF DRAWINGS

FIG. 1A is a vertical sectional view illustrating the configuration of an image transmission unit according to a first embodiment of the present invention.

FIG. 1B is a front view illustrating a distal end surface of the image transmission unit in FIG. 1A.

FIG. 2A is a diagram for explaining the image height of an objective lens in the image transmission unit in FIG. 1A.

FIG. 2B is a diagram for explaining the image height of an objective lens in the related art including two truncated spherical lenses.

FIG. 3 is a diagram for explaining expression (2).

FIG. 4A is a vertical sectional view of an example of the image transmission unit including a spacer.

FIG. 4B is a vertical sectional view of another example of the image transmission unit including the spacer.

FIG. 5A is a diagram for explaining step S1 of a manufacturing method of the image transmission unit.

FIG. 5B is a diagram for explaining step S2 of the manufacturing method of the image transmission unit.

FIG. 5C is a diagram for explaining step S3 of the manufacturing method of the image transmission unit.

FIG. 5D is a diagram for explaining step S4 of the manufacturing method of the image transmission unit.

FIG. 5E is a diagram for explaining step S5 of the manufacturing method of the image transmission unit.

FIG. 5F is a diagram for explaining step S5 of the manufacturing method of the image transmission unit.

FIG. 6 is a vertical sectional view illustrating the configuration of an image transmission unit according to a second embodiment of the present invention.

FIG. 7A is a configuration diagram of one example of an optical device according to a third embodiment of the present invention.

FIG. 7B is a configuration diagram of another example of the optical device according to the third embodiment of the present invention.

FIG. 8 is a front view illustrating a distal end surface of the optical device in FIG. 7A and FIG. 7B.

FIG. 9 is a configuration diagram of one example of a system including the optical device in FIG. 7A and FIG. 7B.

FIG. 10A is a diagram for explaining step S6 of a manufacturing method of the optical device.

FIG. 10B is a diagram for explaining step S21 of the manufacturing method of the optical device.

FIG. 10C is a diagram for explaining step S31 of the manufacturing method of the optical device.

FIG. 10D is a diagram for explaining steps S4 and S5 of the manufacturing method of the optical device.

FIG. 11 is a configuration diagram of an optical device according to a fourth embodiment of the present invention.

FIG. 12 is a vertical sectional view illustrating the configuration of an image transmission unit in the related art.

### DESCRIPTION OF EMBODIMENTS

### First Embodiment

An image transmission unit according to a first embodiment of the present invention will now be described with reference to the drawings.

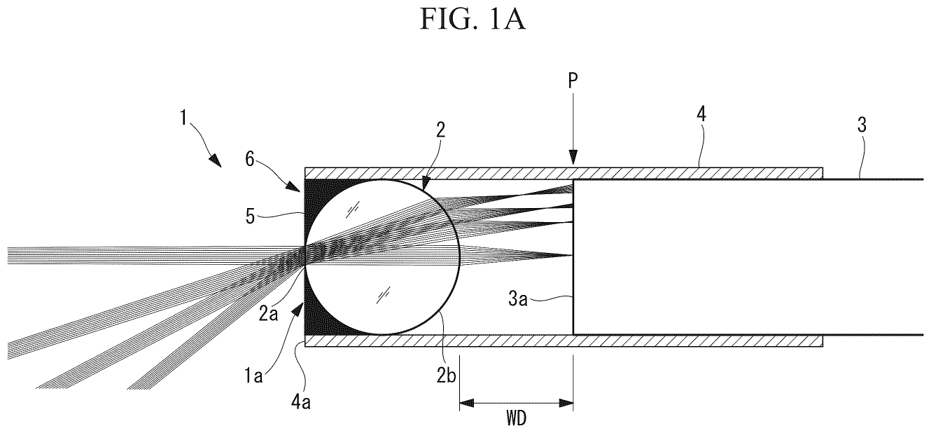

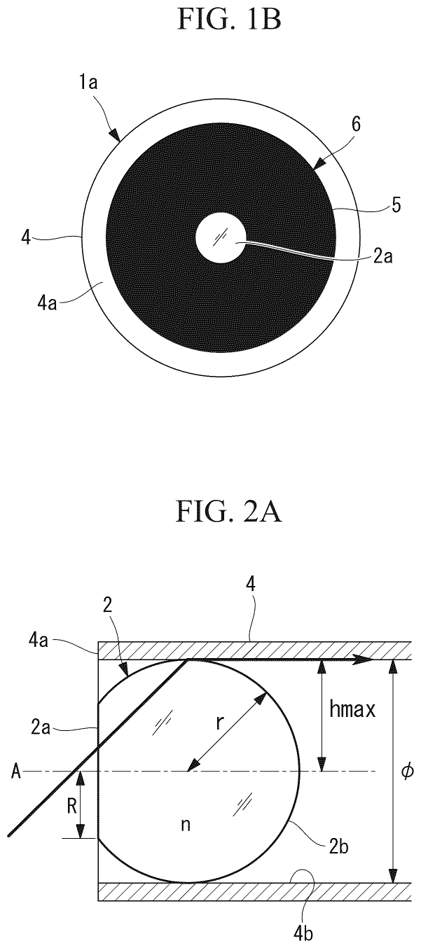

As shown in FIG. 1A and FIG. 1B, an image transmission unit 1 according to this embodiment includes a single objective lens 2, an image transmission medium 3, and a single tubular holding member 4 that holds both the objective lens 2 and the image transmission medium 3.

The image transmission unit 1 is long, and the objective lens 2 and the image transmission medium 3 are disposed at the distal end and the proximal end, respectively, of the image transmission unit 1.

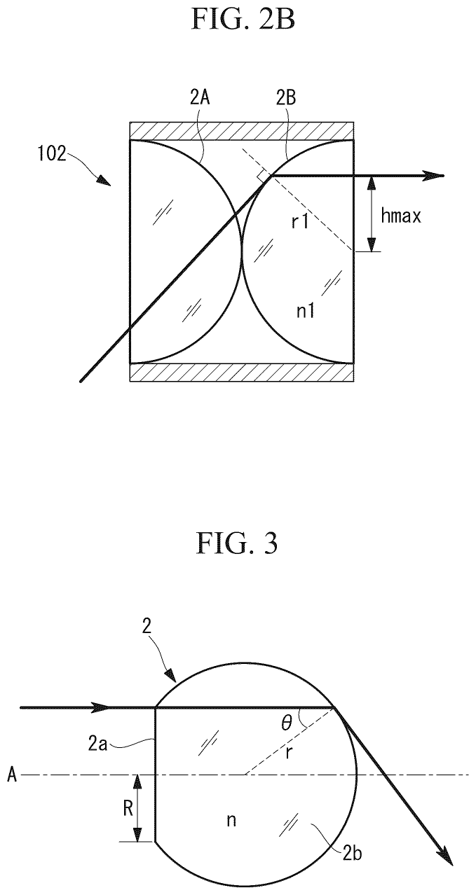

The objective lens 2 is constituted of a single lens formed in a truncated sphere to have a flat surface 2a and a convex spherical surface 2b, and does not include other lenses. A truncated sphere is a three-dimensional shape obtained by cutting a sphere along a single plane. Therefore, the objective lens 2 has the flat surface 2a, which is circular, and the convex spherical surface 2b. The flat surface 2a is disposed at the distal end and is disposed facing an object when the image transmission unit 1 is in use. Preferably, the objective lens 2 is larger than a hemisphere and has the center of curvature of the convex spherical surface 2b located within the objective lens 2. The objective lens 2 has an optical axis A that extends through the center of the flat surface 2a and that is perpendicular to the flat surface 2a (see FIG. 2A). The objective lens 2 is composed of a glass material, such as sapphire or BK7, generally used in optical lenses.

The objective lens 2 may be a perfect truncated sphere, or may have a nearly truncated spherical shape. In other words, the flat surface 2a may be a perfect flat surface, and the convex spherical surface 2b may be a perfect spherical surface. Alternatively, the flat surface 2a and the convex spherical surface 2b may respectively have errors from a perfect flat surface and a perfect spherical surface so long as the image transmission unit 1 satisfies the required optical performance. The errors include, for example, abrasion, defect, or deformation that may occur in the manufacturing process of the image transmission unit 1.

The image transmission medium 3 is an optical member disposed at a side of the convex spherical surface 2b of the objective lens 2 (i.e., toward the proximal end) and extending in the longitudinal direction of the holding member 4. An example of the image transmission medium 3 is a fiber bundle having multiple optical fibers. Another example of the image transmission medium 3 is a relay optical system constituted of at least one lens.

The holding member 4 is a tubular member having openings at opposite end surfaces thereof, and preferably has a fixed inner diameter q over the entire length. The holding member 4 is preferably a round pipe having a circular cross section over the entire length. The holding member 4 is composed of a rigid material, such as metal or synthetic resin, and is preferably composed of metal, such as stainless steel or an aluminum alloy.

The holding member 4 accommodates the objective lens 2 and the image transmission medium 3 therein. The objective lens 2 and the image transmission medium 3 are disposed at the distal end and the proximal end, respectively, of the holding member 4. The flat surface 2a is disposed on the same plane as an annular distal end surface 4a of the holding member 4, and the optical axis A is aligned with the central axis of the holding member 4. In the case where the image transmission medium 3 is constituted of a single optical member (e.g., in the case where the image transmission medium 3 is a fiber bundle), only the distal end portion of the image transmission medium 3 may be held within the holding member 4.

As shown in FIG. 2A, the convex spherical surface 2b is in contact with an inner surface 4b of the holding member 4, and the objective lens 2 is secured to the holding member 4 by friction between the convex spherical surface 2b and the holding member 4. The inner diameter φ of the holding member 4 is smaller than or equal to a diameter 2×r of the objective lens 2, and is preferably slightly smaller than 2×r. In this case, r denotes the radius of the objective lens 2 (i.e., the radius of curvature of the convex spherical surface 2b). Accordingly, by simply press-fitting the objective lens 2 into the holding member 4, the objective lens 2 can be secured to the holding member 4 by friction. In order to prevent the objective lens 2 from breaking during the press-fitting process, it is preferable that 0.8×2r<φ≤2r be satisfied.

The holding member 4 may have a shape other than a cylindrical shape so long as it can hold the objective lens 2 by friction, and may be, for example, a polygonal pipe having a polygonal cross section.

The image transmission medium 3 has a distal end surface 3a facing the convex spherical surface 2b. The distal end surface 3a is disposed at or in the vicinity of a focal plane P of the objective lens 2, and is separated from the convex spherical surface 2b by a predetermined distance WD in a direction extending along the optical axis A.

Light output from the convex spherical surface 2b toward the image transmission medium 3 includes radially expanding light. With the distal end surface 3a being separated from the convex spherical surface 2b by the predetermined distance WD, the expanding light reaches the outermost periphery of the distal end surface 3a or the vicinity thereof, and light passing through the flat surface 2a includes light passing through the outermost periphery of the image transmission medium 3.

The objective lens 2 and the image transmission medium 3 satisfy expression (1) indicated below.

$$r / n < d \leq r \qquad ( 1 )$$

In this case, r denotes the radius of the objective lens 2 (i.e., the radius of curvature of the convex spherical surface 2b), n denotes the refractive index of the objective lens 2, and d denotes the radius of the image transmission medium 3 (i.e., the effective radius of the distal end surface 3a). Preferably, the outer diameter of the image transmission medium 3 is equal to or substantially equal to the outer diameter of the objective lens 2.

In order to enhance the resolution of an image transmitted by the image transmission medium 3, the radius d of the image transmission medium 3 is preferably large. For example, if the image transmission medium 3 is a fiber bundle, the number of optical fibers constituting the fiber bundle increases with increasing radius d, so that the resolution of a transmitted optical image increases. With the radius d being within the range of expression (1), an image formed by the objective lens 2 can be transmitted with high resolution.

FIG. 2A illustrates an image height of the objective lens 2 according to this embodiment that is constituted of a single truncated spherical lens, and FIG. 2B illustrates an image height of an objective lens 102 in the related art that is constituted of two truncated spherical lenses 2A and 2B.

When an object-side telecentric ray is regarded as a principal ray, a maximum image height hmax of the objective lens 102 in the related art is r1/n1, and is smaller than a radius r1 of the truncated spherical lens 2B at the proximal end, n1 being the refractive index of the truncated spherical lens 2B. Therefore, if the image transmission medium 3 used has the radius d that is larger than r1/n1, a peripheral region of the distal end surface 3a that does not receive light from the objective lens 102 does not contribute to image transmission, thus lowering the resolution of the image.

On the other hand, in the objective lens 2 according to this embodiment, the image height is larger than r/n, so that the maximum image height hmax can be increased to a dimension equal to the radius r. Thus, by using the image transmission medium 3 whose radius d is larger than r/n, the image can be transmitted with high resolution without wasting the peripheral region of the distal end surface 3a.

As shown in FIG. 1A and FIG. 1B, the image transmission unit 1 may further include a light blocking member 5 that is provided between the distal end surface 4a of the holding member 4 and the flat surface 2a and that blocks light.

The light blocking member 5 is composed of a cured black-colored adhesive filled in an annular space between the inner surface at the distal end of the holding member 4 and the convex spherical surface 2b. The adhesive is, for example, a resin adhesive, such as epoxy resin or ultraviolet curable resin. With the annular light blocking member 5 surrounding the entire circumference of the flat surface 2a, an aperture 6 is formed at a distal end surface 1a of the image transmission unit 1. The aperture 6 limits the light entering the image transmission medium 3 from the object. By total internal reflection at the convex spherical surface 2b, a light ray that may become stray light can be eliminated.

The objective lens 2 preferably satisfies expression (2) indicated below. In this case, R denotes the radius of the flat surface 2a.

$$R \leq r / n \qquad ( 2 )$$

As shown in FIG. 3, when there is no aperture 6, an on-axis marginal ray entering the objective lens 2 from infinity via the flat surface 2a is defined by the condition for total internal reflection at the convex spherical surface 2b. Therefore, in order for the flat surface 2a to function as the aperture 6, n×sinθ≤sin90°, that is R≤r/n, needs to be satisfied.

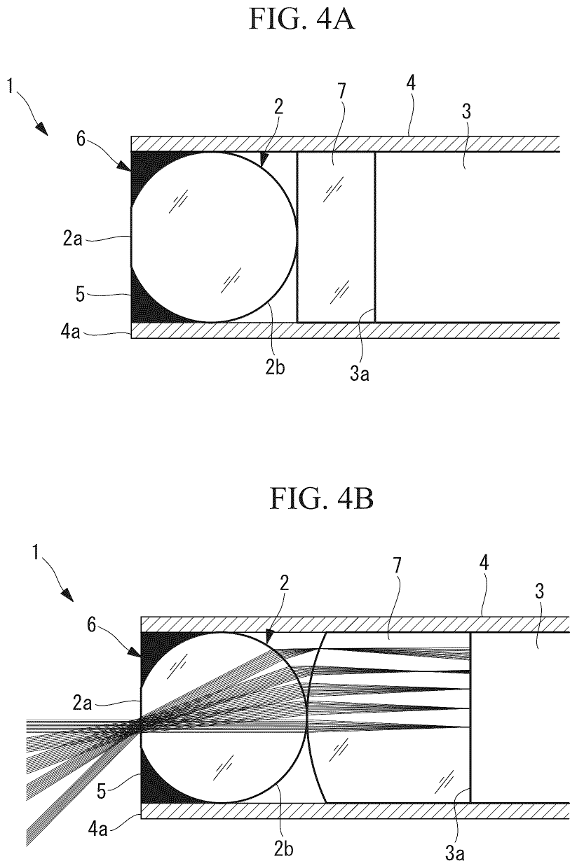

As shown in FIG. 4A and FIG. 4B, the image transmission unit 1 may further include a spacer 7 disposed between the objective lens 2 and the image transmission medium 3. The spacer 7 is an optical member that allows light to pass through, and preferably has a diameter equal to or substantially equal to the diameter of the objective lens 2. The convex spherical surface 2b and the distal end surface 3a are in contact with the distal end surface and the proximal end surface, respectively, of the spacer 7. Therefore, the thickness of the spacer 7 is designed based on the predetermined distance WD and the refractive index of the spacer 7.

An example of the spacer 7 is a parallel plate (see FIG. 4A) having flat surfaces orthogonal to the optical axis A at the objective lens 2 side (i.e., at the distal end) and the image transmission medium 3 side (i.e., at the proximal end). Another example of the spacer 7 is a lens having a curved surface on at least the objective lens 2 side and the image transmission medium 3 side, and is, for example, a plano-convex lens having a convex surface at the objective lens 2 side (see FIG. 4B). The lens 7 has positive refractive power with respect to light entering the lens 7 from the objective lens 2 and passing through the lens 7, and focuses the light from the objective lens 2 onto the distal end surface 3a. Accordingly, the angle of view can be enhanced.

Next, the operation of the image transmission unit 1 will be described.

The image transmission unit 1 is used as an objective optical system of any of various devices, and is used as, for example, an imaging optical system that captures an image of an object or an illumination optical system that illuminates the object.

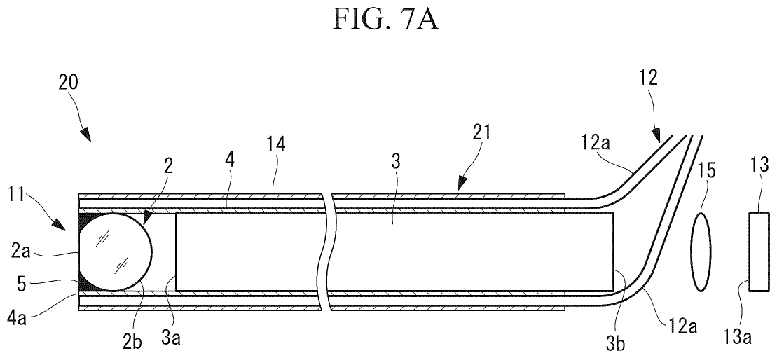

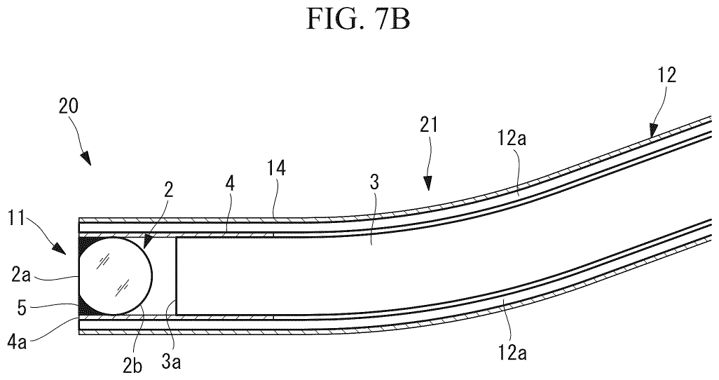

When the image transmission unit 1 is used as an imaging optical system, the light from the object enters the objective lens 2 via the flat surface 2a, is output from the convex spherical surface 2b, and forms an image on the focal plane P. The image is transmitted by the image transmission medium 3 having the distal end surface 3a disposed at or in the vicinity of the focal plane P. The transmitted image is captured by an imaging element 13 (see FIG. 7A) disposed toward the proximal end of the image transmission medium 3.

In this case, in the image transmission unit 1 according to this embodiment, the objective lens 2 is constituted of a single truncated spherical lens alone, and the distal end surface 3a of the image transmission medium 3 is disposed at or in the vicinity of the focal plane P of the objective lens 2. Therefore, the light output from the convex spherical surface 2b enters the distal end surface 3a without being reduced in image height. Furthermore, the image transmission medium 3 has the radius d larger than r/n, and the outermost periphery of the distal end surface 3a also receives the light. Accordingly, the inner diameter q of the holding member 4 defined by the diameter of the objective lens 2 is effectively utilized, so that a high resolution image can be transmitted.

In particular, in the case where the outer diameter of the image transmission medium 3 is equal to or substantially equal to the inner diameter of the holding member 4, the inner diameter φ of the holding member 4 can entirely or substantially entirely contribute to the resolution, so that the resolution can be effectively enhanced.

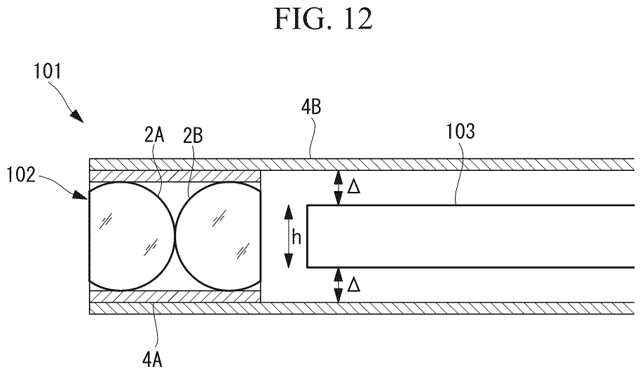

FIG. 12 illustrates an image transmission unit 101 in the related art. The image transmission unit 101 includes two truncated spherical lenses 2A and 2B, a first holding member 4A that holds the two truncated spherical lenses 2A and 2B, an image transmission medium 103, and a second holding member 4B that holds the first holding member 4A and the image transmission medium 103. The second holding member 4B is disposed outside the first holding member 4A.

In the image transmission unit 101, the truncated spherical lens 2B exists at the proximal end so that an image height h is small relative to the diameter of the truncated spherical lens 2A. Therefore, when the image transmission medium 103 used has a radius d equal to the image height h, a region Δ where an image is not projected and that does not contribute to the resolution occurs at the radially outer side of the image transmission medium 103. On the other hand, when the image transmission medium 103 used has a radius d equal to the inner diameter φ, the peripheral region of the image transmission medium 103 does not contribute to image transmission, as mentioned above. Therefore, in either case, the inner diameter φ of the holding member 4B cannot be effectively utilized for enhancing the resolution.

When the image transmission unit 1 is used as an illumination optical system, illumination light is supplied from a light source device to the image transmission medium 3 via a proximal end surface 3b. The illumination light transmitted by the image transmission medium 3 is output from the distal end surface 3a, enters the objective lens 2 via the convex spherical surface 2b, and is radiated toward the object from the flat surface 2a.

In this case, it is similarly advantageous to use the image transmission medium 3 having the radius d larger than r/n. Specifically, the quantity of illumination light that can be transmitted by the image transmission medium 3 increases with increasing radius d. Moreover, the illumination light output from the distal end surface 3a is radiated toward the object with high efficiency via the objective lens 2. Therefore, the inner diameter φ of the holding member 4 defined by the diameter of the objective lens 2 is effectively utilized, so that bright illumination can be achieved.

In the image transmission unit 1 according to this embodiment, the objective lens 2 and the image transmission medium 3 are both held within the single holding member 4. This enables a reduction in the diameter of the image transmission unit 1.

Supposing that the image transmission unit 1 includes two holding members 4A and 4B, as in the image transmission unit 101 in the related art, the outer diameter of the image transmission unit 1 increases by the thickness of a sidewall of the second holding member 4B, and the region 4 that does not contribute to the resolution occurs between the outer peripheral surface of the image transmission medium 3 and the inner peripheral surface of the second holding member 4B.

With the objective lens 2 being larger than a hemisphere, the aperture 6 formed by the light blocking member 5 can be formed between the distal end surface 4a and the flat surface 2a on the distal end surface 1a of the image transmission unit 1, and the objective lens 2 can be tightly secured to the holding member 4 by a frictional force.

One practical example of the image transmission unit 1 is indicated below.

TABLE 1

| | | |
|---|---|---|
| OBJECTIVE LENS | DIAMETER 2 × r | 0.5 mm |
| | GLASS | SAPPHIRE |
| | | (REFRACTIVE |
| | | INDEX OF 1.76) |
| | DIAMETER OF FLAT | 0.08 mm |
| | SURFACE (APERTURE | |
| | DIAMETER) 2 × R | |
| FIBER BUNDLE | OUTER DIAMETER | 0.48 mm |
| HOLDING MEMBER | INNER DIAMETER φ | 0.49 mm |
| (ROUND PIPE) | | |

| ANGLE OF VIEW | APPROXIMATELY |
|---|---|
| | 80 DEGREES |
| DISTANCE (WD) | 0.31 mm |

Next, a manufacturing method of the image transmission unit 1 will be described.

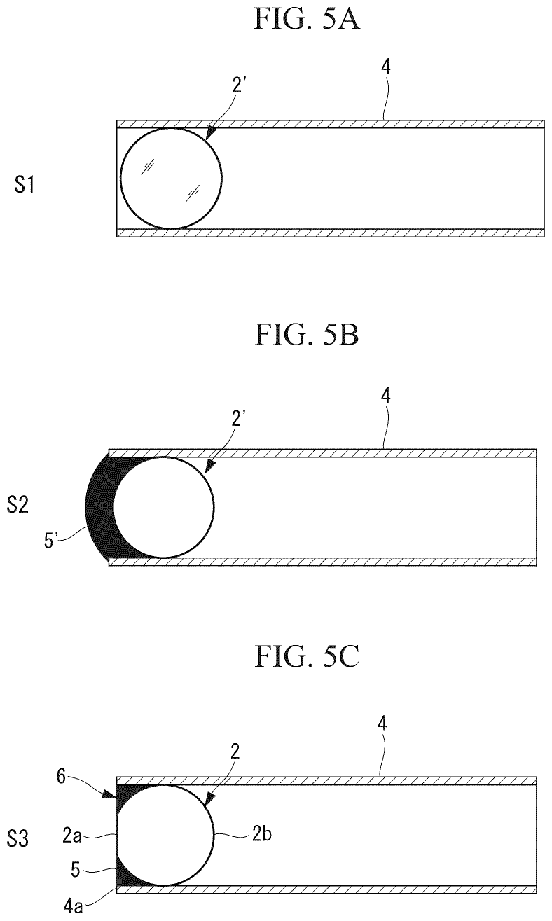

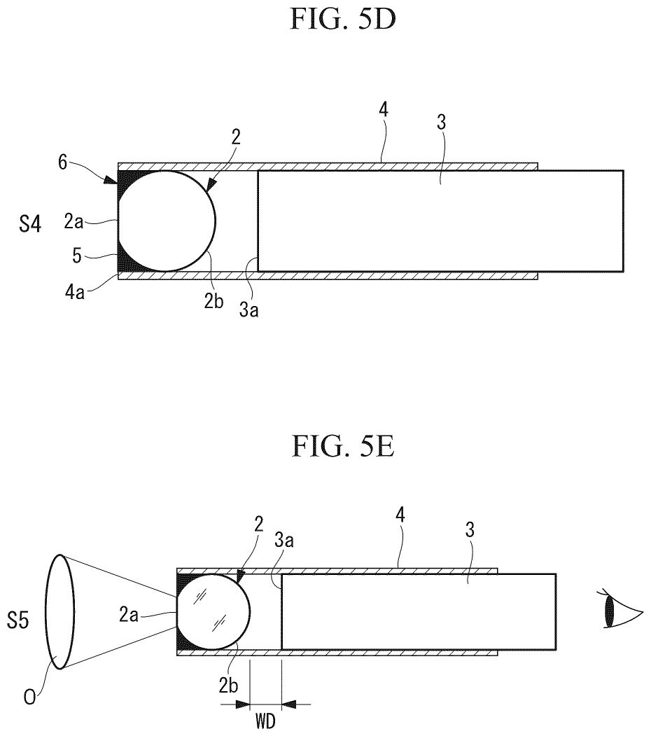

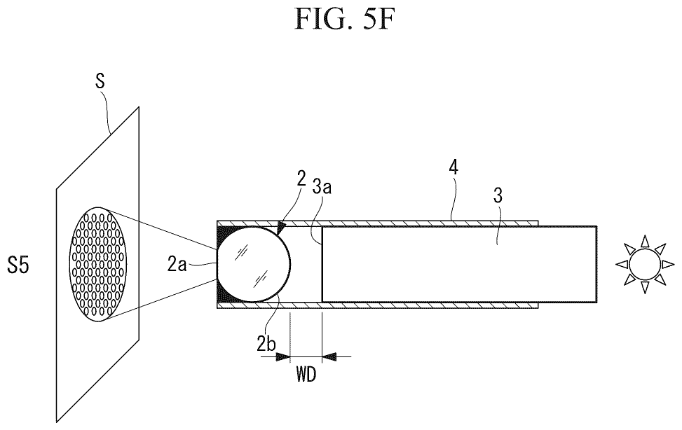

As shown in FIG. 5A to FIG. 5F, the manufacturing method of the image transmission unit 1 includes step S1 for inserting a single spherical lens 2′ into the holding member 4, step S2 for applying an adhesive 5′ over the distal end surface of the spherical lens 2′, step S3 for fabricating the objective lens 2 by forming the flat surface 2a on the spherical lens 2′, step S4 for inserting the image transmission medium 3 into the holding member 4, and step S5 for positioning the objective lens 2 and the image transmission medium 3 relative to each other.

In step S1, the spherical lens 2′ is press-fitted into the distal end of the holding member 4, thereby forming an assembly constituted of the spherical lens 2′ and the holding member 4 (see FIG. 5A). The spherical lens 2′ is secured to the holding member 4 by friction between the outer surface of the spherical lens 2′ and the inner surface of the holding member 4.

Subsequently, in step S2, the adhesive 5′, which is black-colored, is disposed on the distal end surface of the assembly, and the adhesive 5′ is filled into a gap between the distal end surface of the spherical lens 2′ and the inner surface of the distal end of the holding member 4 (see FIG. 5B). Then, the adhesive 5′ is cured. If the image transmission unit 1 to be manufactured does not include the light blocking member 5, step S2 may be omitted.

Subsequently, in step S3, the distal end of the assembly is ground by using a tool (see FIG. 5C). The grinding direction is orthogonal to the longitudinal axis of the holding member 4. The grinding causes the distal end of the holding member 4 and a portion of the spherical lens 2′ to be removed, so that the flat surface 2a is formed. If the black-colored adhesive 5′ is applied in step S2, the adhesive 5′ is also ground together with the spherical lens 2′ and the holding member 4, so that the aperture 6 formed by the light blocking member 5 is also formed simultaneously with the flat surface 2a. In step S3, a plurality of assemblies disposed parallel to each other may be ground simultaneously.

Subsequently, in step S4, the image transmission medium 3 is inserted into the proximal end of the holding member 4 (see FIG. 5D). Where necessary, an adhesive for securing the image transmission medium 3 to the holding member 4 may be applied to at least one of the outer peripheral surface of the image transmission medium 3 and the inner peripheral surface of the holding member 4.

Then, in step S5, the distance WD is adjusted to position the distal end surface 3a of the image transmission medium 3 at or in the vicinity of the focal plane P. For the adjustment of the distance WD, an optical indicator is used. In one example, as shown in FIG. 5E, an object O is disposed in front of the objective lens 2, so that an image of the object O is formed behind the image transmission medium 3. The image transmission medium 3 is positioned where the image is focused. In another example, as shown in FIG. 5F, the image transmission medium 3 is supplied with illumination light, and the illumination light is radiated onto a screen S located in front of the objective lens 2. The image transmission medium 3 is positioned where the image of the illumination light is the sharpest on the screen S.

If the image transmission unit 1 to be manufactured includes the spacer 7, the spacer 7 is inserted into the holding member 4 between step S3 and step S4. The image transmission medium 3 is inserted into the holding member 4 until the convex spherical surface 2b and the distal end surface 3a abut on opposite surfaces of the spacer 7, so that the distal end surface 3a is positioned at an appropriate position. Therefore, the adjustment process of the distance WD, as in FIG. 5E and FIG. 5F, is not required.

Accordingly, in the manufacturing method according to this embodiment, the center of curvature of the convex spherical surface 2b is disposed on the central axis of the holding member 4 by simply press-fitting the spherical lens 2′ into the holding member 4. In other words, high positional accuracy of the objective lens 2 relative to the holding member 4 can be achieved, while a positional adjustment of the spherical lens 2′ relative to the holding member 4 is not required.

In the manufacturing method according to this embodiment, the spherical lens 2′ is secured to the holding member 4 by simply press-fitting the spherical lens 2′ into the holding member 4, and moreover, a positional adjustment of the spherical lens 2′ relative to the holding member 4 is not required, as mentioned above. Furthermore, since the spherical lens 2′ and the image transmission medium 3 are both inserted into the single holding member 4, the number of components to be assembled and the number of assembly steps are reduced. Consequently, the image transmission unit 1 can be readily assembled.

In this embodiment, the image transmission medium 3 is a fiber bundle or a relay optical system, but may alternatively be an imaging element.

In this case, the imaging surface (distal end surface) of the imaging element is disposed at or in the vicinity of the focal plane P of the objective lens 2. An optical image of the object formed on the imaging surface is converted into an electronic signal by the imaging element, and is transmitted in the form of the electronic signal by a signal cable. The radius d of the imaging element is, for example, the radius of a circumscribing circle of the imaging surface, which is rectangular.

In this embodiment, the light blocking member 5 is formed of a black-colored adhesive, but may alternatively be formed of another member.

For example, in step S2, a transparent adhesive may be used in place of the black-colored adhesive 5′, and the light blocking member 5 formed of a light blocking film may be formed on the distal end surface 1a after step S3.

### Second Embodiment

Next, an image transmission unit according to a second embodiment of the present invention will be described with reference to the drawings.

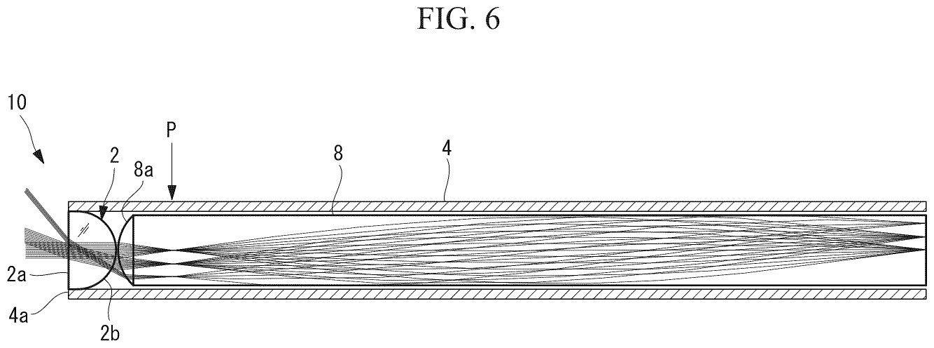

As shown in FIG. 6, an image transmission unit 10 according to this embodiment uses a relay optical system constituted of a GRIN (gradient index) lens 8 as the image transmission medium.

In this embodiment, components different from those in the first embodiment will be described, whereas components identical to those in the first embodiment will be given the same reference signs, and descriptions thereof will be omitted.

The image transmission unit 10 includes the single objective lens 2, the GRIN lens (image transmission medium, relay optical system) 8, and the single holding member 4 that holds both the objective lens 2 and the GRIN lens 8.

The GRIN lens 8 is disposed along the optical axis A at the convex spherical surface 2b (i.e., at the proximal end) of the objective lens 2. The GRIN lens 8 has a distal end surface 8a facing the convex spherical surface 2b. The distal end surface 8a may be in contact with the convex spherical surface 2b or may be separated from the convex spherical surface 2b.

The distal end surface 8a may be a flat surface.

The distal end surface 8a may be a spherical surface that is convex toward the convex spherical surface 2b. In this case, the distal end surface 8a is disposed between the focal plane P and the convex spherical surface 2b, and the focal plane P is located inside the GRIN lens 8. With the distal end surface 8a being a convex surface functioning as a lens in this manner, the angle of view of the image transmission unit 10 can be increased. The convex surface 8a is formed of, for example, an optical adhesive on a flat distal end surface of the GRIN lens.

Light output from the convex spherical surface 2b toward the GRIN lens 8 includes radially expanding light. The expanding light reaches the outermost periphery within the GRIN lens 8, and light passing through the flat surface 2a includes light passing through the outermost periphery of the GRIN lens 8.

The objective lens 2 and the GRIN lens 8 satisfy expression (1) indicated below.

$$r / n < d \leq r \qquad ( 1 )$$

In this embodiment, d denotes an effective radius of the GRIN lens 8. Preferably, the outer diameter of the GRIN lens is equal to or substantially equal to the outer diameter of the objective lens 2. With the radius d being within the range of expression (1) in this manner, an image formed by the objective lens 2 can be transmitted with high resolution.

The image transmission unit 10 may further include the light blocking member 5.

The image transmission unit 10 does not have to include the light blocking member 5 (i.e., the aperture 6). Light that can propagate through the GRIN lens 8 is limited by vignetting at a side surface of the GRIN lens 8. Therefore, even when the aperture 6 does not exist, the brightness of the image transmission unit 10 can be defined by the GRIN lens 8. In relation to this, a radius R of the flat surface 2a may be larger than r/n, as shown in FIG. 6, and may satisfy expression (2) similarly to the first embodiment.

Similar to the image transmission unit 1 according to the first embodiment, the image transmission unit 10 according to this embodiment is used as an objective optical system, and is used as, for example, an imaging optical system or an illumination optical system.

In the image transmission unit 10, the objective lens 2 is constituted of a single truncated spherical lens alone. Light output from the convex spherical surface 2b enters the distal end surface 8a without being reduced in image height. Furthermore, the GRIN lens 8 has a radius d larger than r/n, and the outermost periphery of the GRIN lens 8 also receives the light. Accordingly, when the image transmission unit 10 is used as an imaging optical system, the inner diameter φ of the holding member 4 defined by the diameter of the objective lens 2 is effectively utilized, so that a high resolution image can be transmitted.

With the GRIN lens 8 having the radius d larger than r/n, bright illumination can be achieved when the image transmission unit 10 is used as an illumination optical system.

The objective lens 2 and the GRIN lens 8 are both held within the single holding member 4. This enables a reduction in the diameter of the image transmission unit 10.

With the objective lens 2 being larger than a hemisphere, the objective lens 2 can be tightly secured to the holding member 4 by a frictional force.

One practical example of the image transmission unit 10 is indicated below.

TABLE 2

| | | |
|---|---|---|
| OBJECTIVE LENS | DIAMETER 2 × r | 0.4 mm |
| | GLASS | nBK7 (REFRACTIVE |
| | | INDEX OF 1.51) |
| GRIN LENS | OUTER DIAMETER | 0.35 mm |
| | ON-AXIS | 1.5 |
| | REFRACTIVE INDEX | |
| | N0 | |
| | REFRACTIVE-INDEX | 0.8 |
| | DISTRIBUTION | |
| | CONSTANT √A | |
| HOLDING MEMBER | INNER DIAMETER φ | 0.39 mm |
| (SUS ROUND PIPE) | | |

| | |
|---|---|
| BRIGHTNESS (IMAGE-SIDE ON-AXIS NA) | 0.2 |

Next, a manufacturing method of the image transmission unit 10 according to this embodiment will be described.

The manufacturing method of the image transmission unit 10 includes step S1, step S2, step S31 for inserting the GRIN lens 8 into the holding member 4, and step S41 for positioning the objective lens 2 and the GRIN lens 8 relative to each other.

In step S41, the GRIN lens 8 is positioned where the distal end surface 8a is disposed toward the convex spherical surface 2b relative to the focal plane P. For example, the GRIN lens 8 is positioned where the distal end surface 8a abuts on the convex spherical surface 2b or where the distal end surface 8a is disposed in the vicinity of the convex spherical surface 2b. Therefore, unlike step S4 in the first embodiment, a fine positional adjustment of the GRIN lens 8 is not necessarily required.

The manufacturing method according to this embodiment is similar to the manufacturing method according to the first embodiment in that high positional accuracy of the objective lens 2 can be achieved relative to the holding member 4, while a positional adjustment of the spherical lens 2′ relative to the holding member 4 is not required. Furthermore, similar to the manufacturing method according to the first embodiment, the image transmission unit 10 can be readily assembled.

### Third Embodiment

Next, an optical device according to a third embodiment of the present invention will be described.

In this embodiment, components different from those in the first and second embodiments will be described, whereas components identical to those in the first and second embodiments will be given the same reference signs, and descriptions thereof will be omitted.

As shown in FIG. 7A and FIG. 7B, an optical device 20 according to this embodiment is an endoscope, and includes an image transmission unit 11, an illumination optical system 12, an imaging element (optical element) 13, and a tubular member 14. FIG. 7A illustrates a rigid endoscope, and FIG. 7B illustrates a flexible endoscope.

The image transmission unit 11 is used as an imaging optical system of the endoscope 20. The image transmission unit 11 is the image transmission unit 1 according to the first embodiment or the image transmission unit 10 according to the second embodiment. The image transmission unit 11 in the reference drawings is the image transmission unit 1 including the image transmission medium 3, such as a fiber bundle or a relay optical system, but may alternatively be the image transmission unit 10 including the GRIN lens 8. The objective lens 2 is disposed at the distal end of a long insertion section 21 of the endoscope 20, and forms an image of an object. The image transmission medium 3 extends in the longitudinal direction of the insertion section 21 and transmits the image of the object to the imaging element 13.

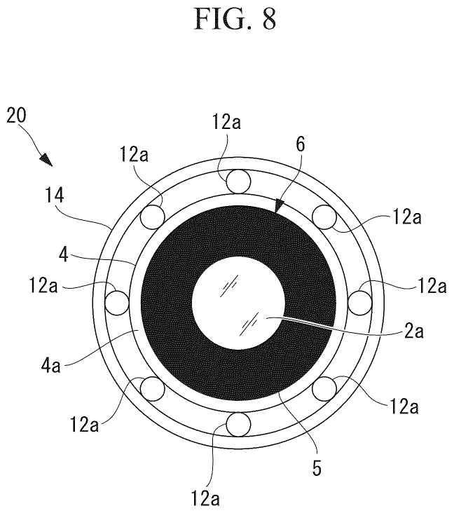

The illumination optical system 12 has at least one optical fiber 12a, preferably, multiple optical fibers 12a. As shown in FIG. 8, the multiple optical fibers 12a are disposed between the holding member 4 and the tubular member 14 in the longitudinal direction of the members 4 and 14, and are arranged in the circumferential direction around the image transmission unit 11. The tubular member 14 is a long cylindrical member that accommodates the image transmission unit 11 and the illumination optical system 12 therein.

The distal end of each optical fiber 12a is disposed at the distal end surface of the insertion section 21 (i.e., the distal end surface of the tubular member 14), whereas the proximal end of each optical fiber 12a is optically connected to a light source device. Each optical fiber 12a optically guides illumination light supplied from the light source device to the proximal end, and radiates the illumination light from the distal end toward the object.

The imaging element 13 is disposed at the proximal end of the image transmission medium 3, captures the image transmitted by the image transmission medium 3 to generate an image signal, and outputs the image signal. A focusing lens 15 may be disposed between the proximal end surface 3b of the image transmission medium 3 and the imaging element 13. The focusing lens 15 forms the image of the object transmitted by the image transmission medium 3 onto an imaging surface 13a of the imaging element 13.

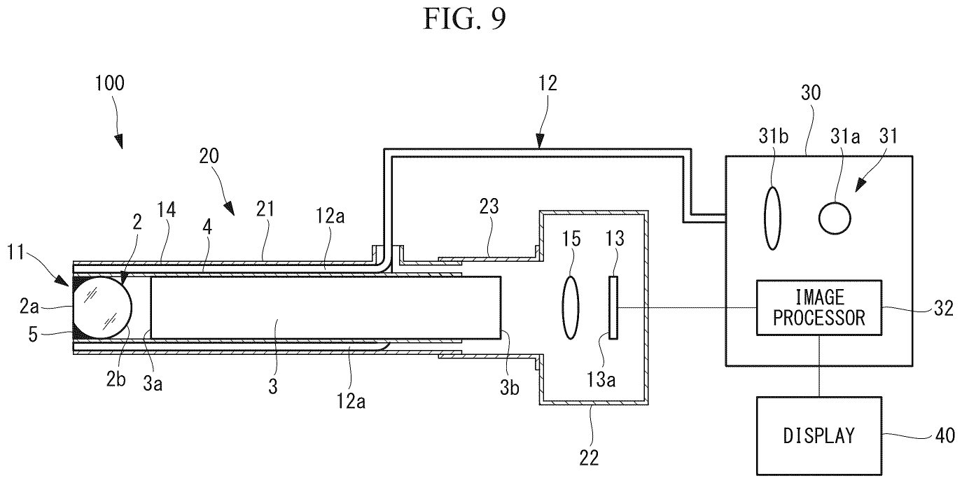

FIG. 9 illustrates an example of an endoscope system 100 including the endoscope 20.

The endoscope system 100 includes the endoscope 20, a housing 30, and a display 40.

The endoscope 20 has the long insertion section 21 and an imaging unit 22 connected to the proximal end of the insertion section 21. The image transmission unit 11 and the illumination optical system 12 are disposed within the insertion section 21, and the imaging element 13 and the focusing lens 15 are disposed within the imaging unit 22.

The imaging unit 22 is detachably connected to the proximal end of the insertion section 21 by a connector 23, whereby the insertion section 21 is replaceable.

The imaging unit 22 may be integrated with the housing 30. In other words, the housing 30 may be connected to the proximal end of the insertion section 21, and the imaging element 13 and the focusing lens 15 may be disposed within the housing 30.

The housing 30 includes an illuminator (light source device) 31 and an image processor 32.

The illuminator 31 has a light source 31a, and the proximal ends of the multiple optical fibers 12a routed from the proximal end of the insertion section 21 are optically connected to the light source 31a. The illuminator 31 may further have a converging lens 31b disposed between the light source 31a and the proximal ends of the multiple optical fibers 12a. The converging lens 31b converges light output from the light source 31a onto the proximal ends of the optical fibers 12a.

The image processor 32 has, for example, a processor and The image processor 32 generates an image of an a memory. object from the image signal output from the imaging element 13, and outputs the image to the display 40.

The display 40 is any display device, such as a liquid crystal display, and displays the image input from the image processor 32.

Accordingly, in this embodiment, the endoscope 20 can be constituted by combining the image transmission unit 11 with the illumination optical system 12. Moreover, by appropriately selecting the image transmission medium 3 or 8, the endoscope 20 of either a rigid type or a flexible type can be manufactured.

By using the image transmission unit 11 as an imaging optical system, an endoscope 20 having a narrow insertion section 21 and having high image resolution can be readily achieved. Consequently, the endoscope 20 and the endoscope system 100 are suitable for use in an elongated lumen, such as a ureter.

In this embodiment, the image transmission medium 3 may be the imaging element 13. In this case, the imaging element 13 is disposed at the distal end of the insertion section 21 together with the objective lens 2. An image signal output from the imaging element 13 is transmitted to the image processor 32 by a signal cable extending through the insertion section 21.

Next, a manufacturing method of the optical device 20 will be described.

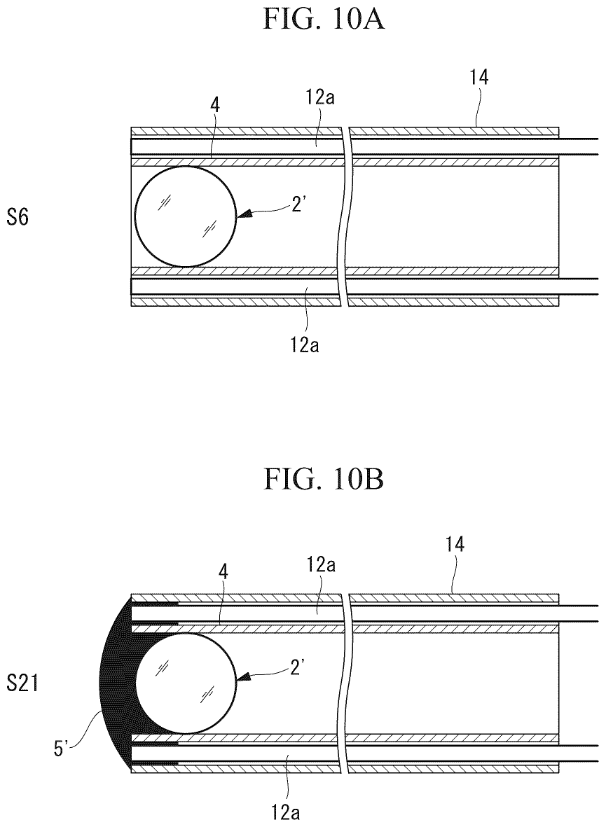

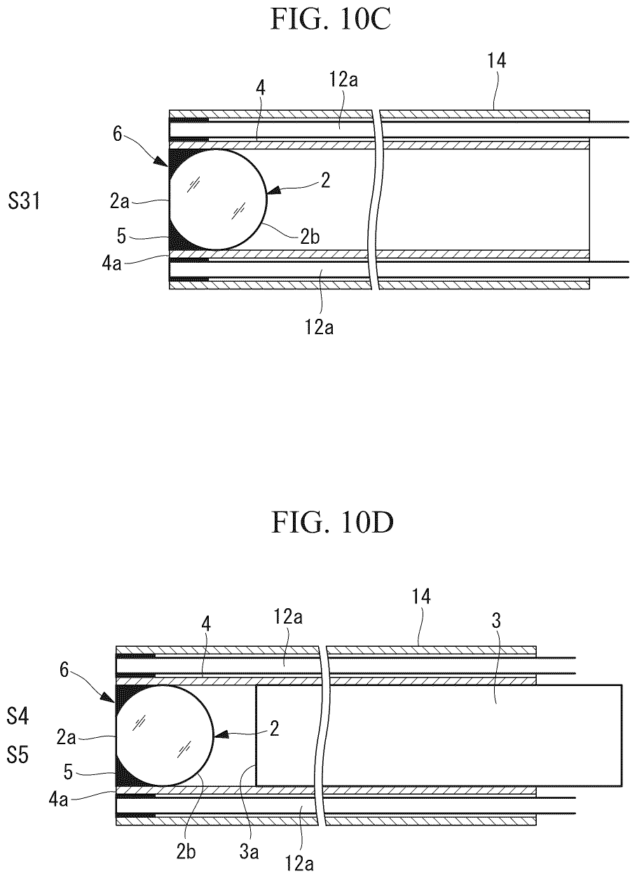

FIG. 10A to FIG. 10D illustrate a part of the manufacturing method of the optical device 20. The manufacturing method of the optical device 20 includes step S1 for inserting the single spherical lens 2′ into the holding member 4, step S6 for inserting an assembly and the optical fibers 12a into the tubular member 14, step S21 for applying the adhesive 5′ over the distal end surface of the spherical lens 2′, step S31 for fabricating the objective lens 2 by forming the flat surface 2a on the spherical lens 2′, step S4 for inserting the image transmission medium 3 into the holding member 4, and step S5 for positioning the objective lens 2 and the image transmission medium 3 relative to each other.

Steps S1, S4, and S5 are as described in the first embodiment.

In step S6 following step S1, a first assembly including the spherical lens 2′ and the holding member 4 is inserted into the tubular member 14, and at least one optical fiber 12a is subsequently inserted into a cylindrical space between the holding member 4 and the tubular member 14 (see FIG. 10A). Accordingly, a second assembly including the spherical lens 2′, the holding member 4, the tubular member 14, and the at least one optical fiber 12a is formed.

Subsequently, in step S21, the black-colored adhesive 5′ is disposed on the distal end surface of the second assembly, and the adhesive 5′ is filled into a space between the distal end surface of the spherical lens 2′ and the inner surface of the distal end of the holding member 4 and into a space between the optical fiber 12a and the members 4 and 14 (see FIG. 10B). Then, the adhesive 5′ is cured.

Subsequently, in step S31, the distal end of the second assembly is ground by using a tool (see FIG. 10C). The grinding direction is orthogonal to the longitudinal axis of the holding member 4. The grinding causes the ends of the members 4 and 14, a portion of the spherical lens 2′, and the distal end of the optical fiber 12a to be removed, so that the flat surface 2a and the aperture 6 are simultaneously formed.

Then, similar to the first embodiment, steps S4 and S5 are performed (see FIG. 10D). Where necessary, the spacer 7 may be inserted into the holding member 4 between step S31 and step S4.

Accordingly, in the manufacturing method according to this embodiment, the application and curing of the adhesive 5′ for forming the light blocking member 5 in step S21 allow the holding member 4, the tubular member 14, and the optical fiber 12a to be secured at the same time. Moreover, in step S31, the spherical lens 2′, the holding member 4, the tubular member 14, and the optical fiber 12a are all ground at the same time. Accordingly, the number of steps can be reduced, so that the optical device 20 can be readily manufactured.

### Fourth Embodiment

Next, an optical device according to a fourth embodiment of the present invention will be described.

In this embodiment, components different from those in the first to third embodiments will be described, whereas components identical to those in the first to third embodiments will be given the same reference signs, and descriptions thereof will be omitted.

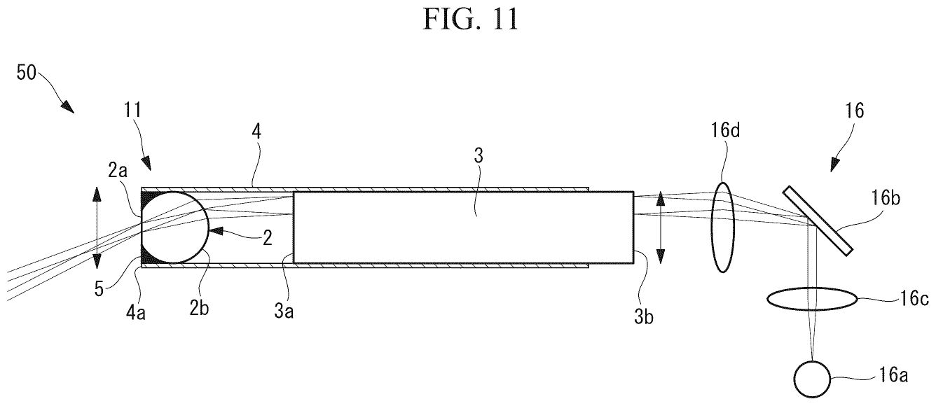

As shown in FIG. 11, an optical device 50 according to this embodiment is a light-scanning illumination device and includes the image transmission unit 11 and a light source device (optical element) 16.

The image transmission unit 11 is the image transmission unit 1 according to the first embodiment or the image transmission unit 10 according to the second embodiment, and is used as an illumination optical system. The image transmission unit 11 in the reference drawing is the image transmission unit 1 including the image transmission medium 3, such as a fiber bundle or a relay optical system, but may alternatively be the image transmission unit 10 including the GRIN lens 8.

The light source device 16 is a light scanner disposed at the proximal end of the image transmission medium 3 and has a light source 16a and a scanning mechanism 16b that scans light (e.g., laser light) output from the light source 16a. The scanning mechanism 16b is, for example, a scanning mirror, such as a galvanometer mirror. The scanning mechanism 16b scans light incident on the proximal end surface 3b in a direction extending along the proximal end surface 3b (see the double-sided arrows), and preferably, scans the light over the entire proximal end surface 3b.

The light scanner 16 may further have a first lens 16c disposed between the light source 16a and the scanning mechanism 16b, and a second lens 16d disposed between the scanning mechanism 16b and the proximal end surface 3b. Each of the lenses 16c and 16d is a double convex lens constituting a collimating optical system. The first lens 16c converts the light output from the light source 16a into a collimated beam, whereas the second lens 16d converts collimated light scanned by the scanning mechanism 16b into converging light.

The light scanned by the scanning mechanism 16b enters the image transmission medium 3 via the proximal end surface 3b, is transmitted by the image transmission medium 3, is output from the distal end surface 3a, enters the objective lens 2 via the convex spherical surface 2b, and is radiated from the flat surface 2a toward an object.

The scanning mechanism 16b may be an optical fiber scanner that scans light in accordance with oscillation of the distal end of an optical fiber. The optical fiber scanner has an optical fiber and a piezoelectric or electromagnetic scanner that oscillates the distal end of the optical fiber. The proximal end of the optical fiber is optically connected to the light source 16a. The light becomes incident on the proximal end surface 3b from the oscillating distal end of the optical fiber while being scanned. In this case, the first lens 16c is a focusing lens that focuses the light output from the light source 16a onto the proximal end surface of the optical fiber, and the second lens 16d is a magnifying lens that magnifies the light scanning range so that the light is scanned over the entire proximal end surface 3b.

Accordingly, in this embodiment, the image transmission unit 11 and the light source device 16 are combined so that an illumination device 50 that radiates or projects light onto an object can be manufactured. The illumination device 50 can efficiently transmit light from a light source device to an object while having a small diameter. Therefore, for example, the illumination device 50 is particularly useful in a robot medical setting where the illumination device 50 is inserted into a medical instrument channel of an endoscope to project light onto tissue inside a biological organism.

Although the illumination device 50 is a scanning illumination device in this embodiment, a non-scanning illumination device is also permissible. Specifically, the light source device 16 does not have to include the light scanner 16. In this case, the light output from the light source 16a simultaneously enters the entire proximal end surface 3b or substantially the entire proximal end surface 3b, and is radiated simultaneously onto the entire illumination range of the object.

Although the embodiments of the present invention and modifications thereof have been described in detail above, the present invention is not limited to the above embodiments and the modifications thereof, and permits various modifications and alterations so long as they do not depart from the scope of the present invention defined in the claims.

### Reference Signs List

1, 10, 11 image transmission unit
2 objective lens
3 image transmission medium
3a distal end surface
4 holding member
4a distal end surface
5 light blocking member
7 spacer
8 GRIN lens (image transmission medium, relay optical system)
12 illumination optical system
13 imaging element (optical element)
13a imaging surface
14 tubular member
15 focusing lens
16 light scanner (optical element, light source device)
20 endoscope (optical device)
50 illumination device (optical device)
100 endoscope system

1. An image transmission unit comprising:
a single objective lens comprising a single truncated spherical lens having a flat surface and a convex spherical surface;
an image transmission medium disposed at a side of the convex spherical surface of the objective lens; and
a single holding member that holds both the objective lens and the image transmission medium, wherein
the objective lens and the image transmission medium satisfy expression (1) indicated below, and
light passing through the flat surface includes light passing through an outermost periphery of the image transmission medium:
$$r / n < d \leq r \qquad ( 1 )$$
where r denotes a radius of the objective lens, n denotes a refractive index of the objective lens, and d denotes a radius of the image transmission medium.

2. The image transmission unit according to claim 1, wherein
the holding member is a tubular member that accommodates the objective lens and the image transmission medium, and the objective lens and the image transmission medium are disposed at a distal end and a proximal end, respectively, of the holding member, and
the image transmission unit further comprises a light blocking member between a distal end surface of the holding member and the flat surface, the light blocking member surrounding the flat surface.

3. The image transmission unit according to claim 1, wherein
the objective lens satisfies expression (2) indicated below:
$$R \leq r / n \qquad ( 2 )$$
where R denotes a radius of the flat surface.

4. The image transmission unit according to claim 1, further comprising a spacer disposed between the objective lens and the image transmission medium.

5. The image transmission unit according to claim 4, wherein the spacer has positive refractive power with respect to light entering the spacer from the objective lens and passing through the spacer.

6. The image transmission unit according to claim 1, wherein
the image transmission medium comprises a fiber bundle, a relay optical system, or an imaging element, and has a distal end surface disposed with a distance from the convex spherical surface, and
the distal end surface is disposed at or in a vicinity of a focal plane of the objective lens.

7. The image transmission unit according to claim 1, wherein the image transmission medium comprises a GRIN lens.

8. The image transmission unit according to claim 7, wherein a distal end surface of the GRIN lens is a spherical surface that is convex toward the convex spherical surface.

9. The image transmission unit according to claim 1, wherein the truncated spherical lens comprises a lens having the flat surface formed thereon by grinding a portion of a spherical lens.

10. An optical device comprising:
an image transmission unit comprising a single objective lens comprising a single truncated spherical lens having a flat surface and a convex spherical surface, an image transmission medium disposed at a side of the convex spherical surface of the objective lens, and a single holding member that holds both the objective lens and the image transmission medium; and
an optical element disposed at a side of the image transmission medium opposite from the objective lens, wherein
the objective lens and the image transmission medium satisfy expression (1) indicated below, and
light passing through the flat surface includes light passing through an outermost periphery of the image transmission medium:
$$r / n < d \leq r \qquad ( 1 )$$
where r denotes a radius of the objective lens, n denotes a refractive index of the objective lens, and d denotes a radius of the image transmission medium.

11. The optical device according to claim 10, wherein the optical element comprises an imaging element that captures an object image formed by the objective lens and transmitted by the image transmission medium.

12. The optical device according to claim 10, further comprising an illumination optical system, wherein
the illumination optical system has at least one optical fiber arranged in a circumferential direction around the image transmission unit.

13. The optical device according to claim 10, wherein the optical element comprises a light source device that supplies light to the image transmission medium.

14. The optical device according to claim 13, wherein the light source device comprises a light scanner that scans the light.

15. The optical device according to claim 10, wherein the truncated spherical lens comprises a lens having the flat surface formed thereon by grinding a portion of a spherical lens.

16. A manufacturing method of an image transmission unit, the manufacturing method comprising:
inserting a single spherical lens into a tubular holding member;
inserting an image transmission medium into the holding member;
forming a flat surface on the spherical lens by grinding an end of the holding member and the spherical lens; and
positioning the spherical lens, having the flat surface formed thereon, and the image transmission medium relative to each other to a position where light passing through the flat surface includes light passing through an outermost periphery of the image transmission medium.

17. The manufacturing method of the image transmission unit according to claim 16, further comprising filling a light blocking member into a space between an inner surface of the holding member and an outer surface of the spherical lens before forming the flat surface.
